(19) United States
(12) Patent Application Publication
(10) Pub. No.: US 2025/0108293 A1
(43) Pub. Date: Apr. 3, 2025

(54) REDUCING LATENCY IN GAME CHAT BY PREDICTING SENTENCE PARTS TO INPUT TO ML MODEL USING DIVISION OF CHAT BETWEEN IN-GAME AND SOCIAL

(71) Applicant: Sony Interactive Entertainment Inc., Tokyo (JP)

(72) Inventors: Deepali Arya, San Mateo, CA (US); Jason Wang, San Mateo, CA (US)

(21) Appl. No.: 18/480,469

(22) Filed: Oct. 3, 2023

(51) Int. Cl. A63F 13/358; A63F 13/87; G06F 40/58

(52) U.S. Cl. CPC A63F 13/358; A63F 13/87; G06F 40/58

(57) ABSTRACT

Techniques are described for determining if chat between two computer gamers requiring translation is related to the game or is simple social chat. Depending on the type of chat, a machine learning (ML) model is selected to predict completion of the sentence being input by the speaker to reduce latency in translating and transmitting the chat.

### FIELD

The present application relates to technically inventive, non-routine solutions that are necessarily rooted in computer technology and that produce concrete technical improvements, and more specifically to reducing latency in game chat by predicting sentence parts to input to ML model using division of chat between in-game and social.

### BACKGROUND

When playing computer games, players often enjoy chatting with each other about the game itself or simple social chat. As understood herein, language translation may be required if two players speak different languages. As also understood herein, translation can introduce latency into the chat.

### SUMMARY

Accordingly, an apparatus includes at least one processor assembly configured to determine whether chat that is input by a first computer gamer to a second computer gamer is related to a computer game being played by the gamers or is not related to the computer game. The processor assembly is configured to, responsive to determining that the chat is related to the computer game, select a first machine learning (ML) model to predict completion of a sentence input by the first computer gamer. The processor assembly is further configured to, responsive to determining that the chat is not related to the computer game, select a second ML model to predict completion of the sentence.

The first and second ML models can reduce latency such as latency in translating the chat.

In examples, the processor assembly is configured to translate the chat from a first human language to a second human language.

In some embodiments, the first ML model can be trained on data from plural players of the computer game, whereas the second ML model can be trained on chat data from plural computer games.

In example implementations the processor assembly can be configured to execute a third ML model to determine whether the chat is related to the computer game or is not related to the computer game. The third ML model may be trained on data that includes chat data and at least one of: voice intonation data, and facial expression data.

In another aspect, an apparatus includes at least one computer medium that is not a transitory signal and that in turn includes instructions executable by at least one processor assembly to execute a first machine learning (ML) model. The instructions are executable to, based on first output from the first ML model, select a second ML model to process chat related to at least one computer game. The instructions further are executable to, based on second output from the first ML model, select a third ML model to process chat not related to the computer game.

In another aspect, a method includes completing a sentence of chat input by a first computer gamer in a first language to translate the chat for a second computer gamer in a second language using a first machine learning (ML) model responsive to the chat being related to a computer game being played by the gamers. The method also includes completing the sentence of chat input by the first computer gamer in the first language to translate the chat for the second computer gamer in the second language using a second ML model responsive to the chat not being related to the computer game being played by the gamers.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in consistent with present principles;

FIG. 2 illustrates an example encoder-decoder system;

FIG. 3 illustrates two game players chatting with each other;

FIG. 4 illustrates three example machine learning (ML) models that can be used for present purposes;

FIG. 5 illustrates example logic in example flow chart format for training the social chat model;

FIG. 6 illustrates example logic in example flow chart format for training the game chat model;

FIG. 7 illustrates example logic in example flow chart format for training the selection model; and

FIG. 8 illustrates example logic in example flow chart format for completing chat sentences to minimize latency.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor assembly may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

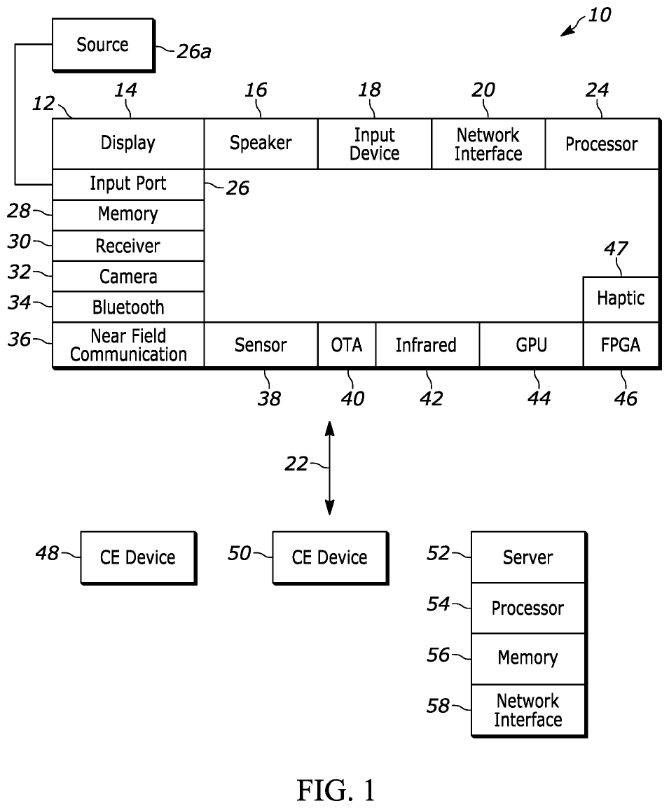

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

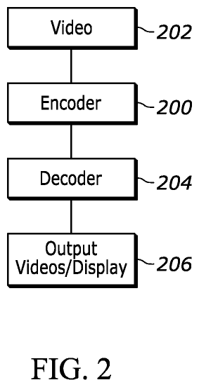

FIG. 2 illustrates a system that includes a video encoder 200 for encoding/compressing videos 202. A video decoder 204 can receive the encoded videos and decode/decompress them into output videos 206.

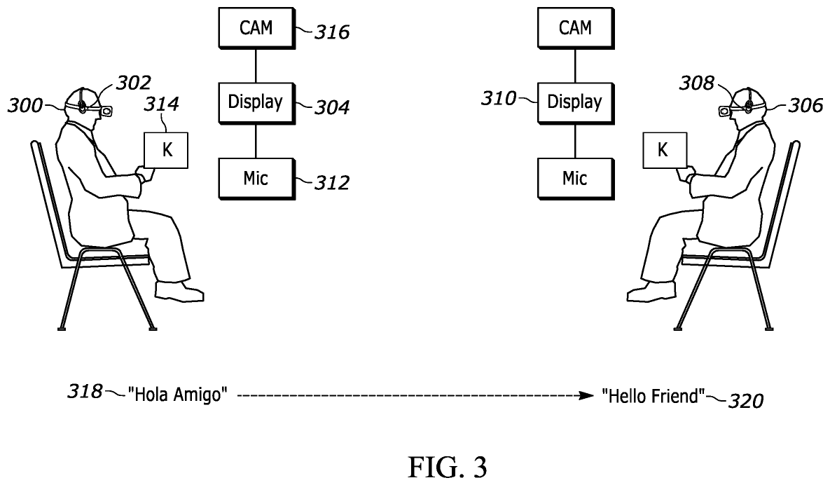

FIG. 3 illustrates a first computer gamer 300 that may wear a headset 302 and/or view a video display 304 to play a computer game that may be a networked game also played by a second computer gamer 306 that may wear a headset 308 and/or view a video display 310 to play the computer game. The first game 300 may input chat to the second gamer 306 either verbally through a microphone 312, which can be converted using speech-to-text techniques to text, and/or by typing the chat in using an input device 314 such as a keyboard. The second gamer 306 may respond to the first gamer 300 using similar techniques. Each game system may also include one or more cameras 316 for imaging the facial expressions of the respective gamers. The display systems shown in FIG. 3 may include some or all of the appropriate computer components shown and described in FIG. 1.

As indicated at 318 in FIG. 3, the chat input by the first gamer 300 can be in a first human language, in the example shown, Spanish. The game system of the first gamer 300 and/or the game system of the second gamer 306 may translate the chat into a second human language as indicated at 320, in this case, English.

Translation of chat can introduce latency into the chat. Particularly in the case of fast action computer games, in which the gamers 300, 306 may be team members cooperating with each other, this can be inconvenient. Present principles address the latency issue by predicting the end of a sentence of chat, either prior to translation or after a portion of an incomplete sentence is first translated, which completion can depend on a division of chat between in-game and social chat as described herein.

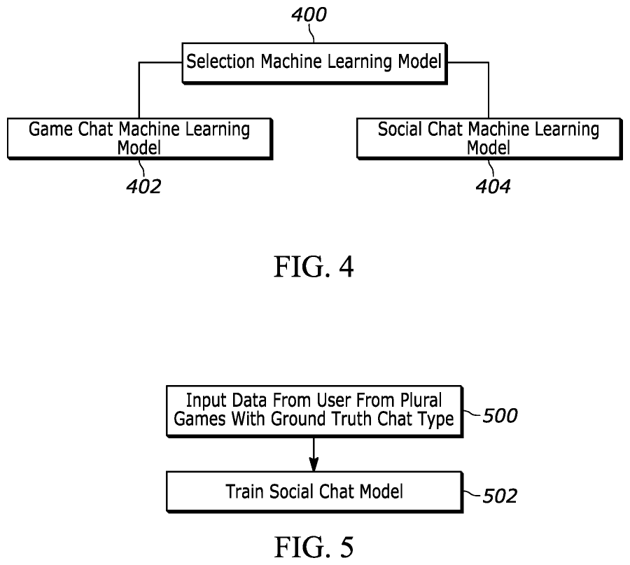

Accordingly, now refer to FIG. 4, which shows a selection ML model 400 configured to select between a game chat ML model 402 and a social chat ML model 404 to be the source of completing a chat sentence between the gamers 300, 306 shown in FIG. 3, for example. Note that as chat is being input, all three models may receive the chat and begin processing the chat. However, while it is the task of the game chat and social chat models 402, 404 to predict the completion of the chat, the selection ML model 400 does not need to wait for a complete chat sentence to be input before selecting which of the other models 402, 404 will be used to predict the complete sentence of the chat.

FIG. 5 illustrates that the social chat model 404 may receive, at state 500, an input training set of chat sentences input by users of plural computer games in general with indications of ground truth chat type, i.e., whether each item in the training set is related to a computer game or is not related to a computer game (in other words, is social chat that does not involve game context). The model is trained on the data at state 502.

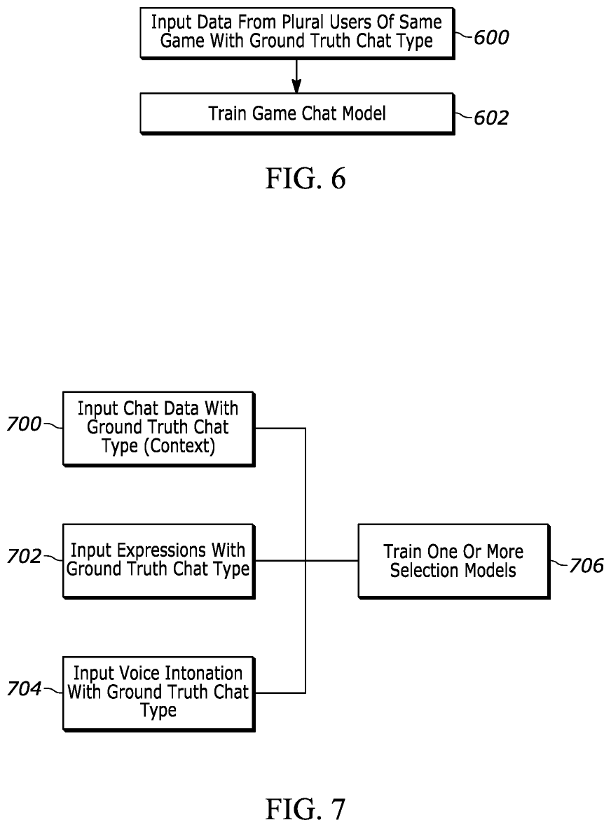

On the other hand, the training set of data input at state 600 in FIG. 6 to train the game chat model at state 602 may include chat data of plural users of the same game being played by the gamers in FIG. 3, along with ground truth indication of the type of chat each chat is.

In contrast, FIG. 7 illustrates that at least one and in the example shown three sets of training data 700, 702, 704 may be input to the selection model (which itself may include plural ML models) to train the selection model at state 706. In the example shown, chat data with ground truth chat type (game or social) 700 is input. Also, facial expressions along with ground truth chat type associated with those expressions 702 also is used to train the model. If desired, audible information such as voice intonation along with ground truth chat type associated with each intonation 704 may be used to train the selection model. Furthermore, the selection model may maintain history of decisions, so that, for example, if it determines that a first chat sentence portion is classified as social, an immediately following sentence portion may also be so classified.

The selection model further may be trained to recognize game context to classify chat. For example, chat input during high activity game segments may be more likely to be game chat than social chat, whereas chat input during lull times in the game may be more likely to be social chat. Game context may be inferred by motion vectors from the game engine, direct input from the game engine indicating context, and scene recognition applied to video of the game. The intonation/facial expression training data of FIG. 7 also may be used to train the selection model on context, with excited intonation or excited facial expression of a gamer, for example, indicating that the chat is related to the game.

Any of the models shown herein may be trained to translate the chat. For example, the selection model may be trained to translate the chat. Or, a separate model may be used for translation.

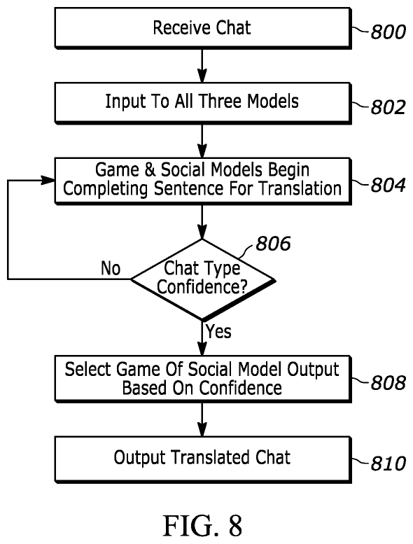

Once the models have been trained, FIG. 8 illustrates how they may be used during game play to reduce latency in translating chat. Chat is received at state 800 and input to all three models in parallel if desired at state 802. Proceeding to state 804, the game and social models 402, 404 shown in FIG. 4 begin to complete a sentence of the chat either after first translating the chat as it is received or prior to translation.

Decision state 806 indicates that in parallel, the selection model 400 shown in FIG. 4 determines the type of chat so that it may select the best model to use to complete the chat sentence. In one embodiment this may be done based on accuracy based on game/chat context ass indicated by a confidence measure which model output is best as between the game chat model 402 and the social chat model 404.

Based on the decision at state 806, the selection model selects which of the models 402, 404 to use at state 808. The output of the selected model is used as the complete chat sentence 810 and if not already translated, translated into the second language.

While particular techniques are herein shown and described in detail, it is to be understood that the subject matter which is encompassed by the present application is limited only by the claims.

What is claimed is:

1. An apparatus comprising:
at least one processor assembly configured to:
determine whether chat that is input by a first computer gamer to a second computer gamer is related to a computer game being played by the gamers or is not related to the computer game;
responsive to determining that the chat is related to the computer game, select a first machine learning (ML) model to predict completion of a sentence input by the first computer gamer; and
responsive to determining that the chat is not related to the computer game, select a second ML model to predict completion of the sentence.

2. The apparatus of claim 1, wherein the first and second ML models reduce latency.

3. The apparatus of claim 1, wherein the first and second ML models reduce latency in translating the chat.

4. The apparatus of claim 1, wherein the processor assembly is configured to translate the chat from a first human language to a second human language.

5. The apparatus of claim 1, wherein the first ML model is trained on data from plural players of the computer game.

6. The apparatus of claim 1, wherein the second ML model is trained on chat data from plural computer games.

7. The apparatus of claim 1, wherein the processor assembly is configured to execute a third ML model to determine whether the chat is related to the computer game or is not related to the computer game.

8. The apparatus of claim 7, wherein the third ML model is trained on data comprising chat data and at least one of: voice intonation data, and facial expression data.

9. An apparatus comprising:
at least one computer medium that is not a transitory signal and that comprises instructions executable by at least one processor assembly to:
execute a first machine learning (ML) model;
based on first output from the first ML model, select a second ML model to process chat related to at least one computer game; and
based on second output from the first ML model, select a third ML model to process chat not related to the computer game.

10. The apparatus of claim 9, wherein the third and second ML models reduce latency.

11. The apparatus of claim 9, wherein the third and second ML models reduce latency in translating the chat.

12. The apparatus of claim 9, wherein the instructions are executable to translate the chat from a first human language to a second human language.

13. The apparatus of claim 9, wherein the second ML model is trained on data from plural players of the computer game.

14. The apparatus of claim 9, wherein the third ML model is trained on chat data from plural computer games.

15. The apparatus of claim 9, wherein the first ML model is trained on data comprising chat data and at least one of: voice intonation data, and facial expression data.

16. A method, comprising:
completing a sentence of chat input by a first computer gamer in a first language to translate the chat for a second computer gamer in a second language using a first machine learning (ML) model responsive to the chat being related to a computer game being played by the gamers; and
completing the sentence of chat input by the first computer gamer in the first language to translate the chat for the second computer gamer in the second language using a second ML model responsive to the chat not being related to the computer game being played by the gamers.

17. The method of claim 16, wherein the first and second ML models reduce latency in translating the chat.

18. The method of claim 16, comprising to translating the chat from the first language to the second language.

19. The method of claim 16, wherein the first ML model is trained on data from plural players of the computer game.

20. The method of claim 16, wherein the second ML model is trained on chat data from plural computer games.
